(19) United States
(12) Patent Application Publication
(10) Pub. No.: US 2006/0153143 A1
(43) Pub. Date: Jul. 13, 2006

(54) System for receiving access request signal in a wireless communication system

(76) Inventors: Jae-Hyok Lee, Seoul (KR); Young-Ky Kim, Seoul (KR); Jae-Ho Jeon, Seongnam-si (KR); Sung-Kwon Jo, Suwon-si (KR); Ji-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/302,494

(22) Filed: Dec. 14, 2005

(30) Foreign Application Priority Data
Dec. 14, 2004 (KR) 2004-105899

(51) Int. Cl. H04B 7/216

(52) U.S. Cl. 370/335; 370/342

(57) ABSTRACT

A system includes a first base station (BS) adapted to generate, upon detecting an access request signal for a second BS and transmitted from a mobile terminal (MT), an access detection message indicating the detection, and a network element coupled between the first and second BS and adapted to receive the access detection message. The second BS is adapted to receive the access detection message from the network element.

### PRIORITY

This application claims the benefit under 35 U.S.C. § 119(a) of an application filed in the Korean Intellectual Property Office on Dec. 14, 2004 and assigned Serial No. 2004-105899, the entire contents of which are hereby incorporated by reference.

### BACKGROUND OF THE INVENTION

1. Field of the Invention

The present invention relates generally to a system for receiving and processing an access request signal from a mobile terminal.

2. Description of the Related Art

Conventional wireless communication systems may enable users to perform communication even while on the move. The wireless communication system has evolved from an early system that provides only voice service to a system that can provide high-speed multimedia service. Wireless communication systems are classified into various types of systems according to their access schemes. The most typical access scheme used for the wireless communication system is a Code Division Multiple Access (CDMA) scheme. CDMA-based mobile communication systems may support different transmission data types, data rates, and transmission methods according to their standard levels. This resulted from the evolution of the communication systems.

Among the CDMA mobile communication systems, a CDMA 2000 1×EV-DO (hereinafter referred to as “1×EV-DO”) system may transmit only the high-rate data. However, there are proposed methods capable of providing voice service even in the 1×EV-DO system.

A first exemplary way to provide voice service in the 1×EV-DO system is Voice over Internet Protocol (VoIP) service that provides voice service using packet data. This method is characterized by point-to-point communication (or 1:1 communication), and inevitably experiences a time delay because it provides voice service based on an Internet protocol (IP). A second way to provide voice service in the 1×EV-DO system is Push-To-Talk (PTT) service. PTT service is characterized by point-to-multipoint communication, and allows a user to perform voice communication with a plurality of users. In PTT service, a particular user transmits voice signals to all other users in a communication group. Of course, even the PTT service can support the point-to-point communication. Such services can contribute to addressing the disadvantages of the 1×EV-DO system that transmits only the high-rate data.

Generally, however, the 1×EV-DO system requires a process of accessing a base station transceiver system (BTS) in order for a user to perform communication. An access process required for performing initial communication in the 1×EV-DO system will now be described using a configuration of a 1×EV-DO system shown in FIG. 1. While the CDMA communication system (e.g., 1×EV-DO system) is discussed in detail along with its problems, similar problems may also arise in other communication systems, and the present invention may be applied in any communication system.

A mobile terminal (MT) 101 of the 1×EV-DO system communicates with its BTS 111 through a wireless channel. The BTS 111, together with other BTSs, is connected to one base station controller (BSC) 121. The BSC 121 can be connected to one or both of a mobile switching center (MSC) 150 and a packet control function (PCF) 131 according to a system implementation method. Generally, the BSC 121 may be connected to the MSC 150 when it provides real-time voice service or receives No. 7 Signaling-based service. Otherwise, the BSC 121 may be connected to a packet data serving node (PDSN) 132 via the PCF 131 when it transmits packet data. Therefore, the MSC 150 may be connected to a public switched telephone network (PSTN) 160, and the PDSN 132 may be connected to a PTT server 170 via an IP network or a public switched data network (PSDN) 140. Although not illustrated in FIG. 1, the MSC 150 may be connected to the PTT server 170 via the PSTN 160.

In this system configuration, the MT 101, when it first enters a particular BTS, may receive a pseudo-random noise (PN) code of the BTS and various information provided from the BTS. After receiving such information, the MT 101, if it desires to transmit data at a certain time, may transmit an access request signal (also “access signal”) to its BTS 111 at random. Upon receiving the access request signal, the BTS 111 transmits an acknowledgement (ACK) signal in response to the access request signal, achieving establishment of a channel.

In some cases, however, even though the MT 101 has transmitted an access request signal, the BTS 111 may fail to receive the access request signal. This may be because a channel for transmitting the access request signal suddenly deteriorates in quality at a particular time due to an abrupt change in channel condition, or a channel environment becomes worse due to an increase in distance between the MT 101 and the BTS 111. In this case, the MT 101 may transmit the access request signal to the BTS 111 using higher power.

Therefore, when the BTS 111 fails to receive an initial access request signal, the MT 101 may transmit the access request signal at higher power, causing an increase in interference to its neighboring MTs. In the system providing voice service such as PTT service, if the BTS fails to receive and process an initial access request signal, a call setup time increases, causing deterioration in quality-of-service (QoS). In addition, in the case where an MT is located in a cell edge of the BTS, the failure to receive an initial access request signal increases interference to neighboring BTSs. Although the CDMA communication system (e.g., 1×EV-DO system) was discussed in detail along with its problems, similar problems may also arise in other communication systems.

### SUMMARY OF THE INVENTION

It is, therefore, an object of the present invention to provide a method and system for correctly receiving and processing an access request signal in a wireless communication system.

It is another object of the present invention to provide a method and system for reducing a call setup time by efficiently receiving an access request signal in a BTS for a 1×EV-DO system.

It is further another object of the present invention to provide a method and system for preventing an MT from transmitting an unnecessary access request signal in a 1×EV-DO system.

It is yet another object of the present invention to provide a method and system for minimizing interference occurring due to an access request signal from an MT in a 1×EV-DO system.

A system according to an exemplary embodiment of the present invention includes a first base station (BS) adapted to generate, upon detecting an access request signal for a second BS and transmitted from a mobile terminal (MT), an access detection message indicating the detection, and a network element coupled between the first and second BS and adapted to receive the access detection message. The second BS is adapted to receive the access detection message from the network element.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a configuration of a 1×EV-DO system;

FIG. 2 is a conceptual network diagram for receiving and processing an access request signal from an MT in a 1×EV-DO system to which the present invention is applicable;

FIG. 3 is a block diagram illustrating an exemplary internal structure of a BTS in a 1×EV-DO system according to an exemplary embodiment of the present invention;

FIG. 4 is a block diagram illustrating a structure of an access request signal receiver included in an RF module according to an exemplary embodiment of the present invention;

FIG. 5 is a signaling diagram illustrating an operation performed when neighboring BTSs receive an access request signal from an MT according to an exemplary embodiment of the present invention;

FIG. 6 is a flowchart illustrating an operation performed when a BTS detects an access request signal in a mobile communication system according to an exemplary embodiment of the present invention; and

FIG. 7 is a flowchart illustrating an operation performed when a BTS receives an access detection message from a neighboring BTS in a mobile communication system according to an exemplary embodiment of the present invention.

### DETAILED DESCRIPTION OF EXEMPLARY EMBODIMENTS

Exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness. Description relating to a BTS throughout the disclosure also applies any wireless communication station to receive an access request signal from a mobile terminal, including but not limited to a base station, BTS, and an access point. A base station as referred to in the disclosure is any wireless communication station to receive an access request signal from a mobile terminal, including but not limited to a base station, BTS, and an access point. A mobile terminal as referred to throughout the disclosure is any wireless communication terminal including but not limited to a mobile phone, PDA and computer. Although the communication system is illustrated with the CDMA communication system (e.g., 1×EV-DO system), the present invention may also be applied to other communication systems. An access request signal as referred to in the disclosure is any request made by a mobile terminal to access a network and/or base station. The network/base station may transmit an acknowledgement signal in response to the request.

A brief description will now be made of a method proposed in an exemplary embodiment of the present invention. In an access process of the current 1×EV-DO system, an MT attempts an access using a PN code of its own BTS. Then the BTS to which the MT belongs may decode the signal from the MT. Therefore, if an MT located in a cell edge transmits an access request signal, only the BTS to which the MT belongs may receive the access request signal even though the channel condition therebetween is poor. According to an exemplary embodiment of the present invention, another BTS neighboring a particular BTS may receive and decode an access request signal to the particular BTS. The neighboring BTS, receiving the access request signal to another BTS, delivers the decoded access request signal to the particular BTS so that the particular BTS may transmit an ACK signal to an MT that transmitted the access request signal. Such method may have many benefits including reducing an access time. The particular BTS and its neighboring BTSs may be the same and include the same elements.

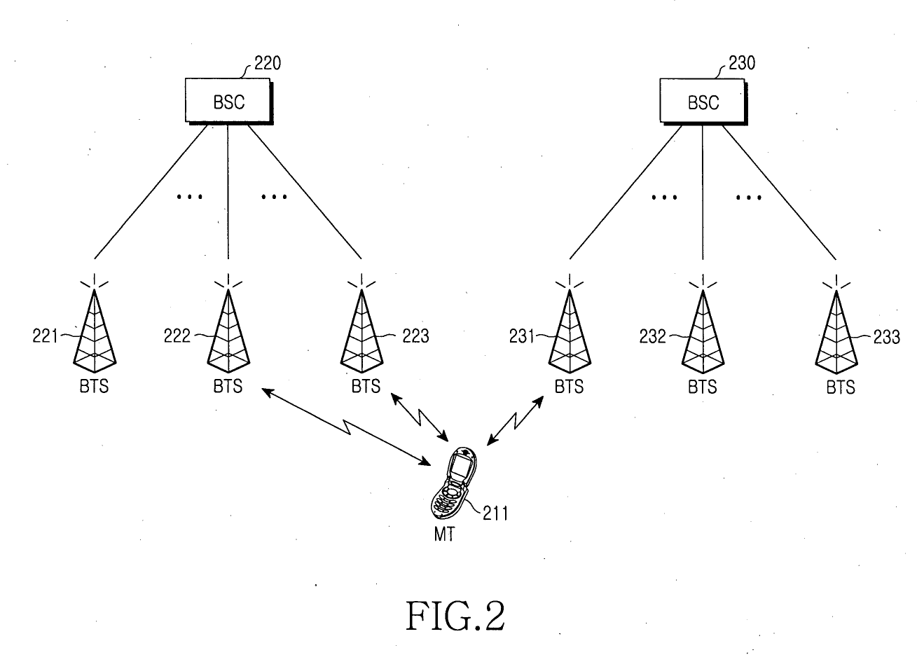

FIG. 2 is a conceptual network diagram for receiving and processing an access request signal from an MT in a 1×EV-DO system to which the present invention is applicable. With reference to FIG. 2, a detailed description will now be made of an operation of receiving an access request signal from an MT in a 1×EV-DO system to which the present invention is applicable.

Referring to FIG. 2, there are shown different BSCs 220 and 230. The BSCs 220 and 230 will be referred to as a first BSC 220 and a second BSC 230, respectively. The first BSC 220 has a plurality of BTSs 221, 222 and 223 as its lower nodes, connected thereto, and the second BSC 230 has a plurality of BTSs 231, 232 and 233 as its lower nodes, connected thereto. An MT 211 is located in a cell edge of at least one of the BTSs. It is assumed herein that the MT 211 is located in a cell edge of a particular BTS so that other BTSs neighboring the particular BTS can also receive a signal transmitted from the MT 211. That is, a plurality of BTSs 222, 223 and 231 capable of receiving a signal from the MT 211 are illustrated in FIG. 2. Each of the BTSs has a radio frequency (RF) unit capable of receiving and decoding signals to its neighboring BTSs. A detailed structure of the BTS will now be described in more detail with reference to the accompanying drawings.

As described above, every BTS may have RF modules capable of decoding an access request signal transmitted by an MT included in its neighboring BTS. Therefore, a BTS having the RF modules, upon receiving an access request signal from an MT not included therein, can decode the access request signal and determine an MT and a BTS from/to which the access request signal was transmitted. The BTS according to an exemplary embodiment of the present invention, upon receiving an access request signal being transmitted to another BTS, may generate a message for delivering the access request signal to the corresponding BTS and transmits the generated message to its upper node (e.g., BSC, MSC). In the following description, a message used by a particular BTS to detect an access request signal to another BTS and transmit the detected access request signal to the corresponding BTS will be referred to as an “access detection message.” Therefore, a BSC, upon receiving an access detection message generated and provided by a particular BTS which is its lower node connected to thereto, can deliver the access detection message to the corresponding BTS. However, if the particular BTS is a BTS a lower node connected to another BSC, the access detection message may be processed in such network elements as an MSC, a PCF and a PDSN. Therefore, in order to equally perform this process, every access detection message may be processed in the MSC or the PDSN which is the uppermost node.

In an alternative method, when the BTSs and the BSCs are all connected to an IP network, each BTS may directly deliver the generated access detection message to other BTSs. In the following description, the alternative method in which the BTSs and the BSCs are all connected to an IP network will not be discussed to avoid redundancy because the same description is applicable to both methods.

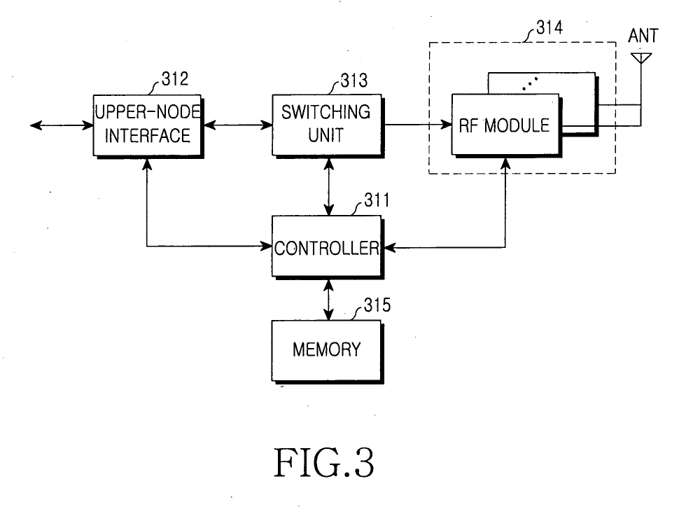

FIG. 3 is a block diagram illustrating an exemplary internal structure of a BTS in a 1×EV-DO system according to an exemplary embodiment of the present invention. With reference to FIG. 3, a detailed description will now be made of an internal structure of a BTS in a 1×EV-DO system according to an exemplary embodiment of the present invention. A particular BTS and its neighboring BTSs may have the same physical configuration.

The BTS may include an upper-node interface 312 for interfacing with its upper node. The upper-node interface 312 receives data to be transmitted to an MT, from the upper node, and provides the received data to a switching unit 313. Further, the upper-node interface 312 receives a signal transmitted from the MT via the switching unit 313, and delivers the received signal to the upper node. In addition, the upper-node interface 312 performs interfacing on control signals or control messages exchanged between a controller 311 and a particular upper node. The BTS includes therein the switching unit 313 to connect the upper-node interface 312 to a corresponding RF module in an RF unit 314. That is, the switching unit 313 performs a switching operation of delivering a signal received from an MT via an RF module to a BTS via the upper-node interface 312, and/or delivering data to be transmitted to the MT, received from the BTS via the upper-node interface 312, to a corresponding RF module.

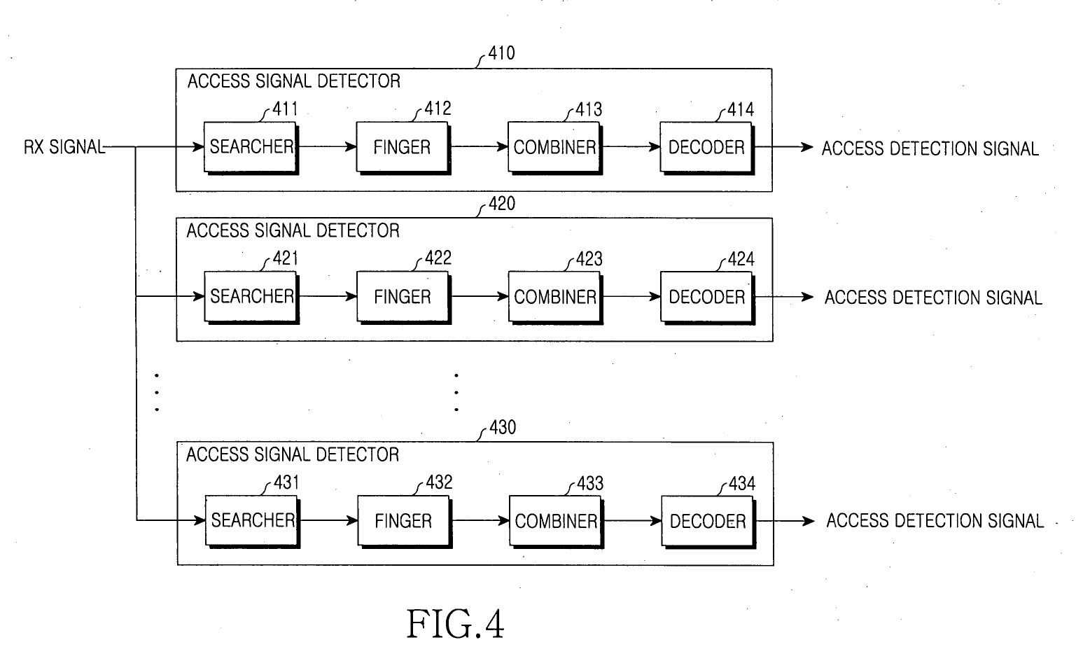

The RF unit 314 includes a plurality of RF modules, and each of the RF modules performs communication with one MT using a predetermined channel frequency resource. The RF unit 314 has a structure for receiving and detecting an access request signal transmitted from a particular MT to a neighboring BTS according to an exemplary embodiment of the present invention. The structure for detecting an access request signal will be described later in more detail with reference to FIG. 4. The RF unit 314, upon detecting an access request signal transmitted from an MT included its own BTS or an MT included in another BTS, delivers the detected access request signal to the controller 311.

The controller 311 may control all modules in its BTS. Also, the controller 311 can serve as a scheduler. The controller 311 receives and processes a control message or a control signal received from an upper node. Further, the controller 311 generates a control signal or a control message to be transmitted to an upper node, and delivers the generated control signal or control message to the upper node via the upper-node interface 312. The control message can include scheduling information or BTS operation information. In a method according to an exemplary embodiment of the present invention in which the corresponding BTS detects an access request signal transmitted by an MT to another BTS, the controller 311 may generate an access detection message including information on the MT and information on above-stated another BTS. The controller 311 delivers the generated access detection message to an upper network element via the upper-node interface 312 to deliver the access detection message to the corresponding BTS. In addition, upon receiving an access detection message from another BTS, the controller 311 transmits an ACK signal to a corresponding MT or disregards the received access detection message. A detailed description of this operation will be made later with reference to the accompanying drawings.

A memory 315 stores data necessary for a control operation of the controller 311 and data generated during the control operation. The memory 315 further stores therein information on neighboring BTSs and PN code information of the corresponding BTS. In addition, the memory 315 can store information on an MT that currently performs data communication with the corresponding BTS. Moreover, the memory 315 stores various data required in the controller 311 of the BTS.

FIG. 4 is a block diagram illustrating a structure of an access request signal receiver included in an RF module according to an exemplary embodiment of the present invention. With reference to FIG. 4, a detailed description will now be made of a structure and operation of an access request signal receiver included in an RF module according to an exemplary embodiment of the present invention.

An access request signal receiver according to an exemplary embodiment of the present invention includes a plurality of access signal detectors 410, 420 and 430, all of them having the same internal structure. For convenience purpose, only the access signal detector 410 among the access signal detectors 410, 420 and 430 will be described. A signal received via an antenna ANT is input to a searcher 411 after being subject to predetermined signal processing. The searcher 411 is a device for detecting the received signal using a PN code of a corresponding BTS. Therefore, if the searcher 411 is a searcher for detecting its own BTS's signal, it detects a signal using a PN code for its own BTS. However, if the searcher 411 is a searcher for detecting a signal of a neighboring BTS, it detects a BTS signal using a PN code for the corresponding BTS. In order to detect an access signal transmitted to a neighboring BTS using a PN code for the neighboring BTS, the searcher 411 may have access frame offset information (e.g., information relating to an access frame offset) of the neighboring BTS. This is because in 1×EV-DO rev. A, in order to decode an access frame, the searcher 411 may have knowledge of a correct start point of an access frame.

Upon detecting an access preamble signal after detecting the access request signal received from each MT, the searcher 411 may output the detected access preamble signal to a finger 412. The finger 412 performs phase alignment on the signal received from the searcher 411, and outputs the phase-aligned signal to a combiner 413. The combiner 413 combines the phase-aligned signal received from the finger 412, and outputs the combined signal to a decoder 414. The decoder 414 may be a decoder for decoding an access frame signal received over an access channel, rather than a decoder for decoding a voice signal or a data signal. The decoder 414 outputs the decoded access detection signal to a controller 311 of FIG. 3. In the same manner, the access request signal detectors 410, 420 and 430 detect access request signals transmitted to their corresponding BTSs and output the detected access request signals to the controller 311. In this way, the controller 311 can generate an access detection message and deliver the generated access detection message to the corresponding BTS.

An exemplary embodiment of the present invention can transmit detected access information to a corresponding BTS using a selected one of the following two methods. A first method transmits an output signal of the combiner 413, i.e., an input signal to the decoder 414, to a BTS that uses a corresponding PN code. This method transmits the intact input signal of the decoder 414 to the BTS that uses the corresponding PN code. This method may improve reception performance by combining signals received from other BTSs before decoding the received signals. However, this method may increase the amount of transmission data. A second method transmits a result signal obtained by decoding an access capsule in a BTS that detected an access preamble, i.e., an output signal of the decoder 414, to a BTS that uses a corresponding PN code. This method may have many benefits including but not limited to the small amount of transmission data.

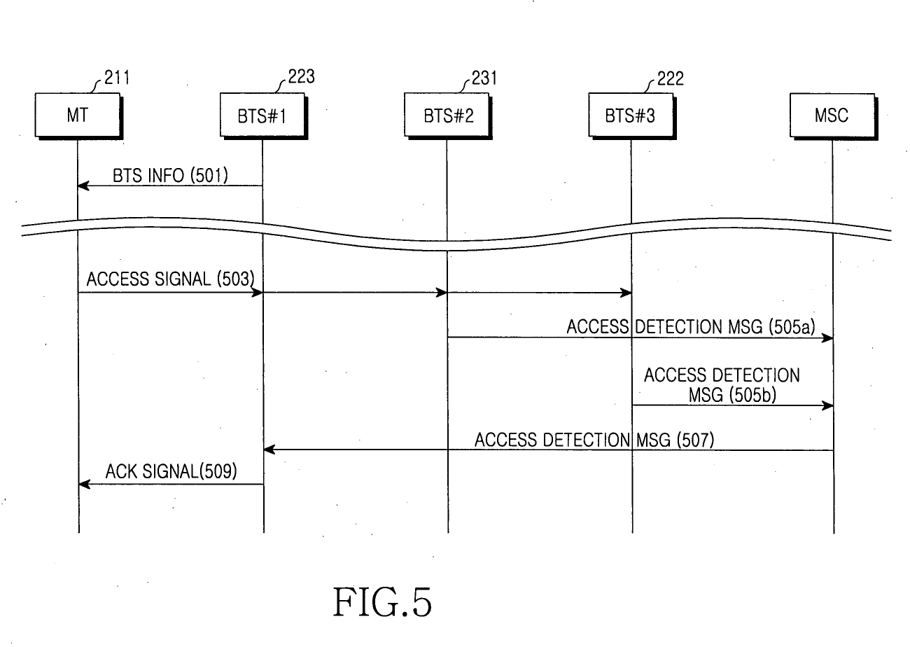

FIG. 5 is a signaling diagram illustrating an operation performed when neighboring BTSs receive an access request signal from an MT according to an exemplary embodiment of the present invention. With reference to FIG. 5, a detailed description will now be made of an operation performed when neighboring BTSs receive an access request signal from an MT according to an exemplary embodiment of the present invention. It will be assumed in FIG. 5 that BTSs 222, 223 and 231 shown in FIG. 2 receive an access request signal from an MT 211 also shown in FIG. 2.

An MT 211 is an MT included in a first BTS 223. Therefore, when the MT 211 enters the first BTS 223 or is powered ON in the first BTS 223, it receives BTS information in step 501. The MT 211 stores the received BTS information in its memory. Thereafter, if there is a communication request, the MT 211 transmits an access request signal to the first BTS 211 to perform communication in step 503. In this case, however, the first BTS 223 may fail to receive the access request signal transmitted by the MT 211. Because the MT 211 is located in a cell edge of the first BTS 223, a second BTS 231 and a third BTS 222, which are the neighboring other BTSs, may receive the access request signal transmitted by the MT 211. In the conventional 1×EV-DO system, a BTS may regard every MT signal that does not use its own PN code, as an interference signal. However, as described with reference to FIGS. 3 and 4, an exemplary embodiment of the present invention can receive all access request signals among the interference signals.

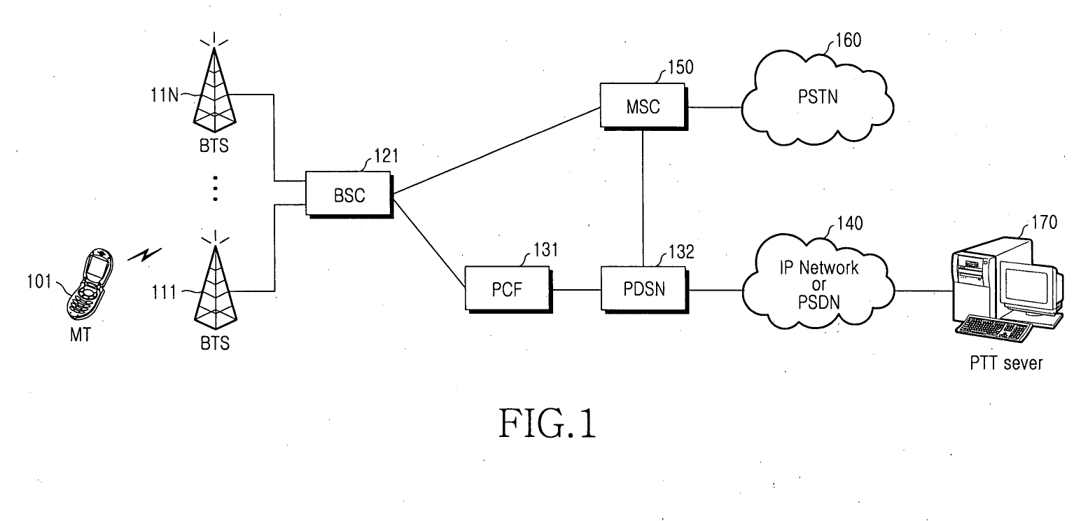

Upon receiving the access request signal, the neighboring BTSs 231 and 222 may generate their own access detection messages and deliver the generated access detection messages to an MSC 150 in steps 505a and 505b, respectively. In FIG. 5, because it is assumed that the BTSs are connected to different BSCs as shown in FIG. 2, it is shown that the access detection messages are delivered up to the MSC 150. However, if the BTSs are connected to the same BSC, the MSC 150 can be replaced with the BSC in FIG. 5. If an upper node of the BSC is a PCF or a PDSN as described with reference to FIG. 1, the MSC 150 may also be replaced with the PCF or the PDSN. It will be assumed herein that the subject of receiving an access detection message from each BTS is the MSC 150.

Upon receiving the access detection message, the MSC 150 can determine a target BTS to which it should deliver the received access detection message, by analyzing BTS information included in the received access detection message. After determining a target BTS to which the access detection message should be delivered, the MSC 150 extracts access information from the access detection message, and delivers the access detection message to the first BTS 223 which is the corresponding BTS, in step 507. Upon receiving the access detection message, the first BTS 223 generates an ACK signal and transmits the generated ACK signal to the corresponding MT 211 in step 509. In this communication method, the MT 211 is not required to retransmit the access request signal with higher power.

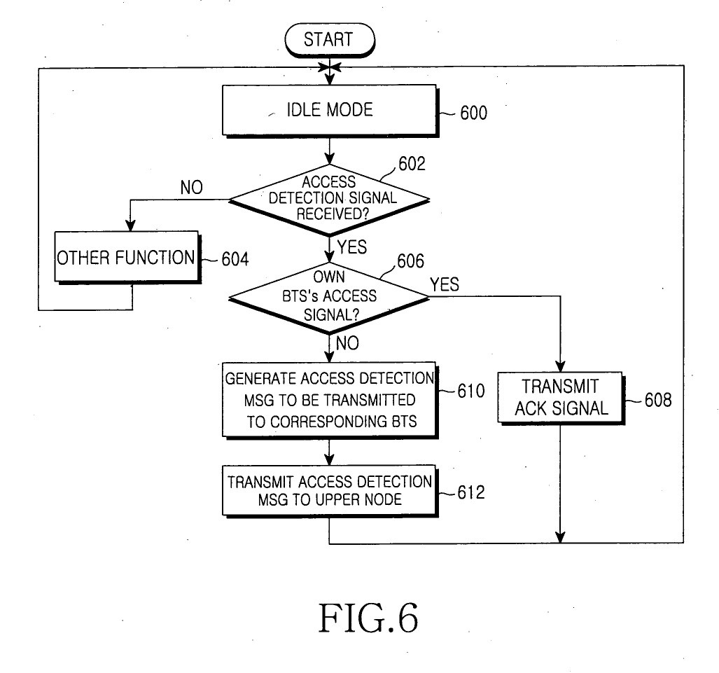

FIG. 6 is a flowchart illustrating an operation performed when a BTS detects an access request signal in a mobile communication system according to an exemplary embodiment of the present invention. With reference to FIG. 6, a detailed description will now be made of an operation performed when a BTS detects an access request signal in a mobile communication system according to an exemplary embodiment of the present invention.

A controller 311 of a BTS maintains an idle state in step 600. In the idle state, the controller 311 waits for occurrence of various events, such as an access request signal from another MT and generation of data to be transmitted from an upper node to an MT. If a particular event occurs in the idle state, the controller 311 determines in step 602 whether an access detection signal has been received from an RF unit 314. If it is determined that the access detection signal has been received, the controller 311 proceeds to step 606. Otherwise, the controller 311 proceeds to step 604 where it performs other function, and then returns to step 600.

However, if it is determined in step 602 that the access detection signal has been received, the controller 311 determines in step 606 whether the received access detection signal is its own BTS's access request signal. In this determination process, the controller 311 can determine whether the received access detection signal is an access request signal from an MT included in its own BTS or an access request signal from an MT included in a neighboring BTS, depending on which searcher and finger the received access request signal has passed through, for example, in the RF module of FIG. 4.

If it is determined in step 606 that the received access detection signal is an access request signal from an MT included its own BTS, indicating the normal case, the controller 311 delivers an ACK signal to the corresponding MT in step 608. The ACK signal may set up a channel or may be accompanied by setting up the channel.

However, if it is determined in step 606 that the received access detection signal is not an access request signal from an MT included its own BTS, the controller 311 generates in step 610 an access detection message to be transmitted to a corresponding BTS in which the MT is included. Preferably, the access detection message includes information on an MT and information on a BTS in which the MT is included. After generating the access detection message, the controller 311 delivers the generated access detection message to a particular upper node via an upper-node interface 312 in step 612. In this manner, the controller 311 can deliver an access detection message to a corresponding BTS. The access detection message delivered through the upper-node interface 312 is transmitted in the method shown in FIG. 5.

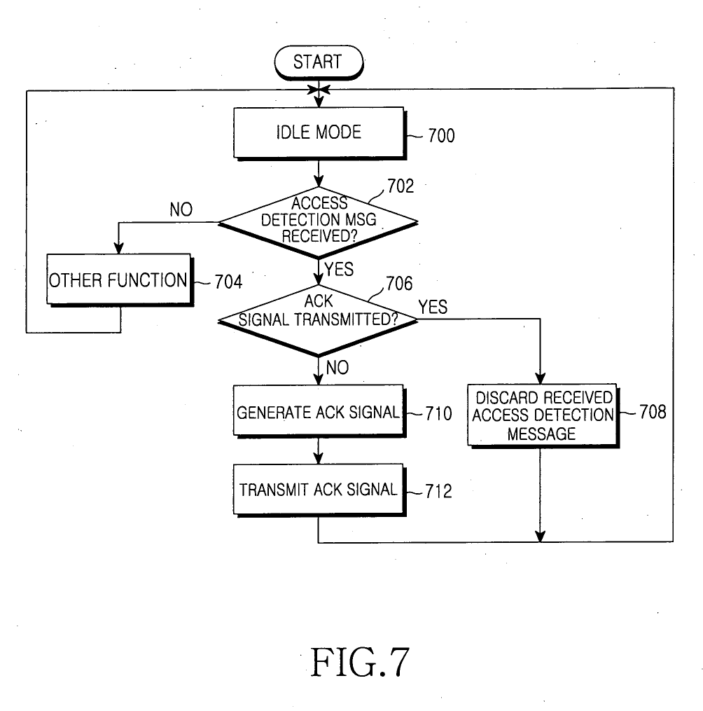

FIG. 7 is a flowchart illustrating an operation performed when a BTS receives an access detection message from a neighboring BTS in a mobile communication system according to an exemplary embodiment of the present invention. With reference to FIG. 7, a detailed description will now be made of an operation performed when a BTS receives an access detection message from a neighboring BTS and delivering the received access detection message to a corresponding BTS in a mobile communication system according to an exemplary embodiment of the present invention.

A controller 311 of a BTS maintains an idle state in step 700. The idle state refers to the idle state described in connection with FIG. 6. Upon detecting an event signal in the idle state, the controller 311 determines in step 702 whether an access detection message has been received. If it is determined that the access detection message has been received, the controller 311 proceeds to step 706. Otherwise, the controller 311 proceeds to step 704 where it performs other function, and then returns to step 700.

In step 706, the controller 311 determines if it has transmitted an ACK signal to an MT from which the access detection message was received. That is, the controller 311 can determine if it has transmitted an ACK signal by determining whether the MT is currently in communication, has started communication, or is in preparation for start of communication. If it is determined in step 706 that it has transmitted an ACK signal, the controller 311 discards the received access detection message in step 708. In this case, because even the BTS to which the MT belongs is normally receiving and processing an access request signal from the MT, the controller 311 does not require the access detection message. The BTS is designed such that it determines in step 706 whether transmission of an ACK signal is completed, upon receiving the access detection message. By doing so, it is possible to increase resource efficiency of the system, and prevent the ACK signal from being repeatedly generated. However, because the access request signal is not frequently generated, the controller 311 can directly perform steps 710 and 712 without steps 706 and 708.

However, if it is determined in step 706 that the ACK signal is not transmitted, the controller 311 generates an ACK signal to be transmitted to a corresponding MT in step 710, and transmits the ACK signal to the corresponding MT using the RF unit 314 in step 712. In this manner, a BTS that has failed receive an access request signal transmitted by an MT located in a cell edge of a corresponding BTS at a particular time, can prevent the MT from retransmitting the access request signal.

As can be understood from the foregoing description, in the CDMA 2000 1×EV-DO system, a BTS may receive all access request signals transmitted from its own MT and MTs belonging to other BTSs. The BTS, upon receiving an access request signal from an MT belonging to a neighboring BTS, informs the neighboring BTS of the receipt of the access detection message. When the neighboring BTS has not detected the request on its own, such action may reduce a call setup time. In addition, the BTS may prevent the MT from retransmitting the access request signal at higher power which may contribute to a reduction in power consumption of the MT and a reduction in reverse interference of the system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system comprising:
a first base station (BS) adapted to generate, upon detecting an access request signal transmitted by a mobile terminal (MT) for a second BS, an access detection message indicating the detection;
a network element coupled between the first and second BSs and adapted to receive the access detection message; and
the second BS adapted to receive the access detection message from the network element.

2. The system of claim 1, wherein the first base station is adapted to detect the access request signal by using a pseudo-random noise (PN) code of the second BS.

3. The system of claim 1, wherein the second BS is adapted to, upon receiving the access detection message after transmitting an acknowledgement signal in response to the access request signal, discard the received access detection message.

4. The system of claim 1, wherein the network element is a base station controller (BSC).

5. The system of claim 1, wherein the access detection message comprises information relating to the MT and information relating to the second BS.

6. The system of claim 1, wherein the first BS comprises a plurality of searchers adapted to use pseudo-random noise (PN) codes of a plurality of BSs.

7. The system of claim 6, wherein the plurality of searchers is adapted to use frame offsets of the plurality of BSs.

8. The system of claim 6, wherein the first BS further comprises:
a plurality of fingers coupled to the plurality of searchers for phase-aligning; and
a plurality of combiners to combine output signals of the plurality of fingers.

9. The system of claim 8, wherein the first BS further comprises a plurality of decoders for decoding output signals of the plurality of combiners.

10. A method comprising the steps of:
upon detection by a first base station (BS) of an access request signal transmitted by a mobile terminal (MT) for a second BS, generating an access detection message indicating the detection; and
delivering the access detection message to a network element adapted to deliver the access detection message to the second BS.

11. The method of claim 10, wherein the first base station is adapted to detect the access request signal by using a pseudo-random noise (PN) code of the second BS.

12. The method of claim 10, wherein the access detection message comprises information relating to the MT and information relating to the second BS.

13. The method of claim 10, wherein the first BS comprises:
a plurality of searchers adapted to use pseudo-random noise (PN) codes of a plurality of BSs.

14. The system of claim 13, wherein the plurality of searchers is adapted to use frame offsets of the plurality of BSs.

15. The method of claim 13, wherein the first BS further comprises:
a plurality of fingers coupled to the plurality of searchers for phase-aligning; and
a plurality of combiners to combine output signals of the plurality of fingers.

16. The method of claim 15, wherein the first BS further comprises a plurality of decoders for decoding output signals of the plurality of combiners.

17. A method comprising the steps of:
upon receipt by a second base station (BS) of an access detection message indicating detection by a first BS of an access request signal for the second BS, determining whether the second BS has previously transmitted to a mobile terminal an acknowledgement (ACK) signal in response to the access request signal; and
if the second BS has not transmitted an ACK signal to the MT prior to the determination, generating an ACK signal and transmitting the generated ACK signal to the MT.

18. The method of claim 17, further comprising the step of discarding the received access detection message if the second BS has transmitted an ACK signal to the MT prior to the determination.

19. The method of claim 17, wherein the access detection message comprises information relating to the MT and information relating to the second BS.

20. The method of claim 17, wherein the first BS comprises:
a plurality of searchers adapted to use pseudo-random noise (PN) codes of a plurality of BSs.
